(19) United States
(12) Patent Application Publication
(10) Pub. No.: US 2006/0269118 A1
(43) Pub. Date: Nov. 30, 2006

(54) Method of inspecting defects in photomask having a plurality of dies with different transmittances

(75) Inventors: Myoung-Soo Lee, Suwon-si (KR); Seong-Woon Choi, Suwon-si (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 11/369,576

(22) Filed: Mar. 7, 2006

(30) Foreign Application Priority Data
May 25, 2005 (KR) 10-2005-0044244

(51) Int. Cl. G06K 9/00

(52) U.S. Cl. 382/144

(57) ABSTRACT

Provided is a method of inspecting defects in a photomask having dies with different transmittances from each other due to correction treatments. A method of inspecting defects corrects light signals transmitted through the dies or source light irradiating the dies by using transmittance maps of the dies.

### CROSS-REFERENCE TO RELATED PATENT APPLICATION

This application claims the benefit of Korean Patent Application No. 10-2005-0044244, filed on May 25, 2005, in the Korean Intellectual Property Office, the disclosure of which is incorporated herein in its entirety by reference.

### FIELD OF THE INVENTION

The present invention relates generally to a method of inspecting a semiconductor manufacturing apparatus, and more particularly, to a method of inspecting defects in a photomask having a plurality of dies with different transmittances.

### BACKGROUND OF THE INVENTION

As semiconductor devices become increasingly integrated, their design rules become tighter, which requires techniques capable of more accurately forming micro-patterns in manufacturing semiconductor devices. Thus, it is increasingly important to manage the photo-lithography process for forming micro-patterns. In particular, the shot-to-shot uniformity within a semiconductor substrate greatly affects the yield of semiconductor devices.

One approach to enhance the shot-to-shot uniformity within a semiconductor substrate is a method of regionally changing transmittances in a photomask used for photo-lithography. When manufacturing a photomask, non-uniformity may occur. To correct the non-uniformity, the manufactured photomask is inspected, and then the transmittance thereof is corrected. For example, using a laser, phase grating patterns are formed on the back of a photomask or shading elements are formed in a photomask. The transmittance can be corrected in units of a die, and a transmittance correction map for each of the dies can be used. Such a photomask whose transmittances are corrected in units of areas is called a customized photomask.

To form a customized photomask, a method of inspecting defects in which light transmittances of dies in the photomask are simply compared with each other is commonly used. However, there is a problem with this method. An inherent transmittance difference of a die may be confused with a transmittance difference caused by a defect. Pattern shaped defects or undesired particles can affect the transmittance. One apparatus for inspecting defects is disclosed in U.S. Pat. No. 6,363,166 by Mark Joseph Wihl et al. entitled “AUTOMATED PHOTOMASK INSPECTION APPARATUS”.

FIG. 1 shows inspection results of a photomask having dies with different transmittances from each other, which are obtained using a conventional method of inspecting defects. FIG. 1 shows inspection errors that can occur when inspecting a photomask 50 having difference transmittances. Transmittances of reference dies 10b, 20b, 30b, and 40b in the right column in FIG. 1 are not corrected, while transmittances of inspection dies 10a, 20a, 30a, and 40a in the left column are corrected in different degrees. For this test, the transmittances of the dies 10a, 20a, 30a, and 40a in the left column are corrected by making them by 3, 6, 9, and 12% lower, respectively compared to those of the dies 10b, 20b, 30b, and 40b in the right column, respectively. Here, the dies 10a, 20a, 30a, and 40a in the left column and the dies 10b, 20b, 30b, and 40b in the right column may all be formed with the same pattern, or dies in the same row, for example, dies 10a and 10b, may be formed with the same pattern.

The dies 10a and 20a, having 3% and 6% corrected transmittances, were inspected by lowering the inspection sensitivity (indicated by “O” in FIG. 1), while the die 40a having 12% corrected transmittance were not inspected due to an error caused by many defect identifications (indicated by “X” in FIG. 1) in spite of no pattern difference inspected between the dies 40a and 40b. The inspections for die 30a, having 9% corrected transmittances, were performed but, sometimes, were not performed due to the generation of errors (indicated by “Δ” in FIG. 1). Confusion may be caused by the inspection results, such that areas having no defect are determined as areas having defects, or vice versa, which may be caused because such method cannot distinguish transmittance differences of the inspection dies and the reference dies due to defects therebetween due to transmittance correction of the dies.

Accordingly, even if there are no defects, the inspection of defects in dies having different transmittances from each other in a photomask, for example, a customized photomask, may become less reliable. Moreover, since the presence of defects should be confined by additional individual inspections with an optical microscope or electron microscope, the inspection time becomes longer.

### SUMMARY OF THE INVENTION

The present invention provides an economic, reliable method of inspecting defects in a photomask having a plurality of dies with different transmittances from each other.

According to some embodiments of the present invention, there is provided a method of inspecting defects in a photomask, the method including: irradiating the photomask, which has at least one pair of dies having corresponding patterns with each other and different transmittances from each other; detecting light signals transmitted through the one pair of dies; correcting the light signals so as to compensate for the different transmittances of the one pair of dies; and determining whether or not a defect is present in at least one of the one pair of dies by comparing the corrected light signals with each other.

In correcting the light signals, one of the light signals transmitted through the one pair of dies may be normalized with respect to the respective transmittances of the one pair of dies. That is, the normalization is performed by dividing the light signals of the one pair of dies by the transmittances of the respective dies.

The method may further include setting one die of a pair of the dies as a reference die and setting the other of the pair as an inspection die. Determining whether or not a defect is present in the inspection die is performed by comparing the corrected light signals transmitted through the reference die with the corrected light signals transmitted through the inspection die.

The transmittances of the one pair of dies can be obtained using transmittance correction maps. The photomask is, for example, a customized photomask in which the transmittances of the one pair of dies are corrected using respective transmittance correction maps.

Before irradiating, the photomask each of the dies in the photomask a plurality of pixel areas, wherein the operations of irradiating, detecting the light signals, correcting the light signals, and determining the presence of the defects are performed separately for each of the pixels.

According to some embodiments of the present invention, there is provided a method of inspecting defects in a photomask, the method including: preparing the photomask having at least one pair of dies having corresponding patterns with each other and different transmittances from each other; irradiating the one pair of dies with a corrected intensity from the source light a light so as to compensate for the different transmittances of the one pair of dies; detecting light signals transmitted through the one pair of dies; and determining whether or not a defect is present in at least one of the one pair of dies by comparing the intensities of the corrected light signals with each other.

According to some embodiments of the present invention, there is provided a method of inspecting defects in a photomask, the method including: irradiating the photomask, which has at least one pair of dies having corresponding patterns with each other and transmittances corrected by corresponding transmittance maps; detecting light signals transmitted through the one pair of dies; normalizing the light signals using the transmittance correction maps of the one pair of dies; and determining whether or not a defect is present in at least one of the one pair of dies by comparing the normalized light signals with each other.

### BRIEF DESCRIPTION OF THE DRAWINGS

The above and other features and advantages of the present invention will become more apparent by describing in detail exemplary embodiments thereof with reference to the attached drawings in which:

FIG. 1 shows inspection results of a photomask having dies with different transmittances relative to each other, and which are obtained using a conventional method of inspecting defects;

FIG. 2 is a schematic view of a photomask having a pair of dies;

FIG. 3 is a schematic view illustrating transmittance correction maps of the dies in FIG. 2;

FIG. 4 is flow chart illustrating a method of inspecting defects in a photomask according to some embodiments of the present invention; and

FIG. 5 is flow chart illustrating a method of inspecting defects in a photomask according to some embodiments of the present invention.

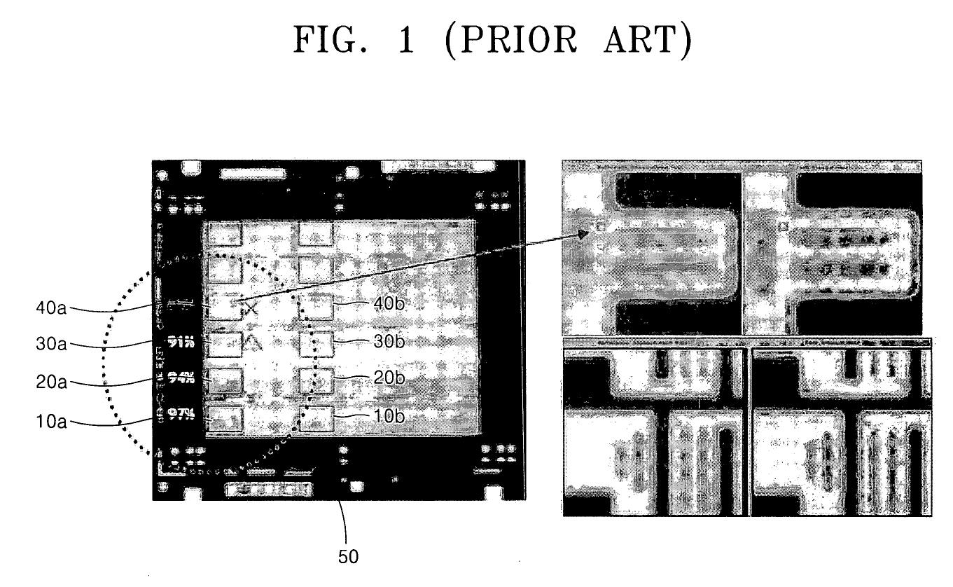

### DETAILED DESCRIPTION OF THE INVENTION

Hereinafter, the present invention will be described by explaining some embodiments of the invention with reference to the attached drawings. In the drawings, the thicknesses of layers and regions are exaggerated for clarity.

The present invention now is described more fully hereinafter with reference to the accompanying drawings, in which some embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise. All publications, patent applications, patents, and other references mentioned herein are incorporated herein by reference in their entireties.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a “first” element, component, region, layer or section discussed below could also be termed a “second” element, component, region, layer or section without departing from the teachings of the present invention. The sequence of operations (or steps) is not limited to the order presented in the claims or figures unless specifically indicated otherwise.

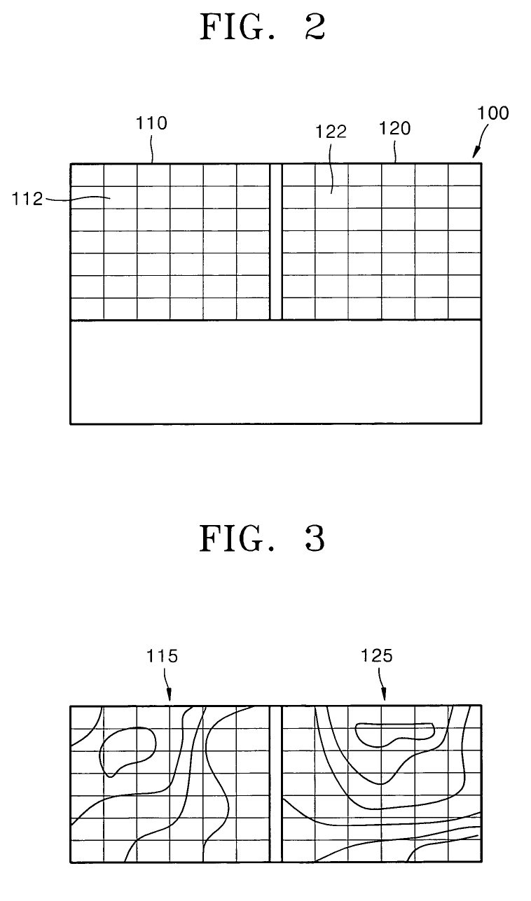

FIG. 2 is a schematic view of a photomask 100 having a pair of dies 110 and 120 with different transmittances relative to each other. Additional dies as well as the dies 110 and 120 can be included in the photomask 100, as would be understood by one skilled in the art. The dies 110 and 120 can be divided into a plurality of pixels. That is, a plurality of pixels 112 are defined in the first die 110 in the form of a matrix and a plurality of pixels 122 are defined in the second die 120 to correspond to the first die 110. The pixels 112 and 122 can be used as a reference unit for the method of inspecting defects.

FIG. 3 is a schematic view illustrating first and second transmittance correction maps 115 and 125 of the dies 110 and 120 in FIG. 2. The transmittances of the dies 110 and 120 can be separately corrected according to pre-inspection results. For example, the transmittances of the first die 110 can be corrected according to the first transmittance correction map 115, and the transmittances of the second die 120 can be corrected according to the second transmittance correction map 125. Here, the transmittance correction maps 115 and 125 are, for example, contour maps of the transmittances of the dies 110 and 120. Accordingly, the transmittances of the dies 110 and 120 can be obtained by averaging the transmittances in the transmittance correction maps 115 and 125, respectively. In addition, the transmittances of the pixels 112 and 122 can be obtained by averaging the transmittances of the pixels in the transmittance correction maps 115 and 125, respectively. A photomask whose transmittances are corrected using the transmittance correction maps 115 and 125 is referred to as a customized photomask.

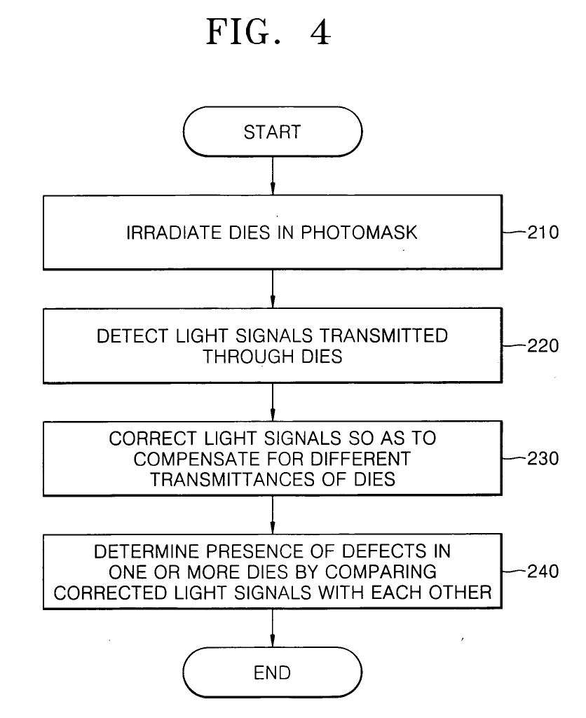

FIG. 4 is flow chart illustrating a method of inspecting defects in a photomask according to some embodiments of the present invention. Referring to FIG. 4, the dies 110 and 120 in the photomask 100, for example, are irradiated in operation 210. The photomask 100 is irradiated, for example, die-by-die or pixel-by-pixel. The light can be supplied from, for example, a laser source.

Next, light signals transmitted through the dies 110 and 120 are detected in operation 220. The intensity of the light signals transmitted through the dies 110 and 120 is dependent on the corrected transmittances of the dies 110 and 120. In addition, defects, for example, non-uniform patterns or undesired particles on the dies 110 and 120, can additionally change the intensity of the transmitted light signals. In particular, a pixel-by-pixel inspection can more precisely detect such defects.

Conventional light detectors, for example, a detector disclosed in U.S. Pat. No. 6,363,166 by Mark Joseph Wihl et al., can be employed for detecting the transmitted light signals. In addition, the light signals may be converted into electrical signals.

Next, the intensities of the light signals are corrected to compensate for the inherently different transmittances of the dies 110 and 120 in operation 230. For example, the intensities of the light signals may be corrected by normalizing the intensities of the light signals with respect to the transmittances of the dies 110 and 120. For example, in the normalization, the intensities of the light signals are divided by the transmittances of the dies 110 and 120, or the light signal of one of the dies 110 and 120 is multiplied by the ratio of the transmittances of the dies 110 and 120. The transmittance of the dies 110 and 120 can be obtained using the transmittance correction maps 115 and 125.

A case where the dies 110 and 120 do not have defects will be first considered. According to the normalization in which the intensities of the light signals are divided by the transmittances of the dies 110 and 120, the intensities of the transmitted light signals and the normalized light signals of the dies 110 and 120 can be obtained by the following formulas. However, the following formulas are simply provided as examples, and embodiments of the present invention should not be construed as being limited to the formulas set forth herein.
I₁=Iₒ×α (1)
I₂=Iₒ×β (2)
I₁ₙ=I₁/α=Iₒ (3)
I₂ₙ=I₂/β=Iₒ (4)
wherein Iₒ represents the intensity of irradiated source light; α represents the transmittance of the first die 110; β represents the transmittance of the second die 120; I₁ represents the intensity of light transmitted through the first die 110; I₂ represents the intensity of light transmitted through the second die 120; I₁ₙ represents a normalized intensity of the light transmitted through the first die 110; and I₂ₙ represents a normalized intensity of the light transmitted through the second die 120. For example, the values of α and β can be obtained from the transmittance correction maps 115 and 125.

Although the values of I₁ₙ and I₂ₙ are ideally the same (=Iₒ) according to the above-described formulas, practically, the values of I₁ₙ and I₂ₙ may be different from each other due to differences between actual transmittances and the values of α and β obtained from the transmittance correction maps 110 and 120.

Meanwhile, according to the other normalization described above, in which the light signal of one of the dies 110 and 120 is multiplied by the ratio of the transmittances of the dies 110 and 120, the first die 110 is set as an inspection die and the second die 120 is set as a reference die. In this case, only I₁ is corrected and compared with I₂. Here, the corrected intensity of light transmitted through the first die 110 can be obtained by the following formula.
I_{1n′}=I₁×β/α=Iₒ×β (5)
where I_{1n′} represents a corrected intensity of light transmitted through the first die 110.

Although the values of I₁ₙ and I₂ are ideally the same (=Iₒ) according to the above-described formulas, the values of I₁ₙ and I₂ₙ can actually be different from each other due to the above-described reason.

When the first die 110 has defects, such as non-uniform patterns or undesired particles thereon, an intensity of light transmitted through the first die 110 can be obtained by the following formula.
I_{1′}=Iₒ×α×δ (6)
where I_{1′} represents an intensity of light transmitted through the first die 110 having defects thereon and δ represents a defect influence factor on transmittance. According to theses formulas, I_{1′n} is substantially equal to δ×I₂ₙ and I_{1′n′} is substantially equal to δ×I₂.

Next, whether or not defects exist in at least one of the dies 110 and 120 is determined by comparing the corrected light signals with each other in operation 240. When the dies 110 and 120 have no defect, the differences in the intensities between the above-described corrected light signals, for example, between I₁ₙ and I₂ₙ or between I_{1n′} and I₂, would be insignificant. However, if the reference die, the second die 120, has no defect but the inspection die, the first die 110, has one or more defects, the difference in practice between the intensities becomes significant. Accordingly, if the differences in the intensities between the corrected light signals of dies 110 and 120 are greater than a predetermined value, the first die 110 may be considered to have defects.

According to some embodiments of the present invention, defects on a photomask can be detected by normalizing different transmittances of a transmittance corrected photomask 100, such as a customized photomask, thereby enhancing reliability of inspecting defects in the photomask and greatly reducing additional inspection time for defects using optical or electron microscopy, resulting in more efficient defect inspection.

Meanwhile, when the dies 110 and 120 are inspected pixel-by-pixel, the above-described operations 210 through 240 are repeatedly performed for the pixels. Accordingly, when all the pixels are inspected, the inspection of the dies 110 and 120 is completed. The pixel-by-pixel inspection can be used to make a pixel-based defect map for the dies 110 and 120.

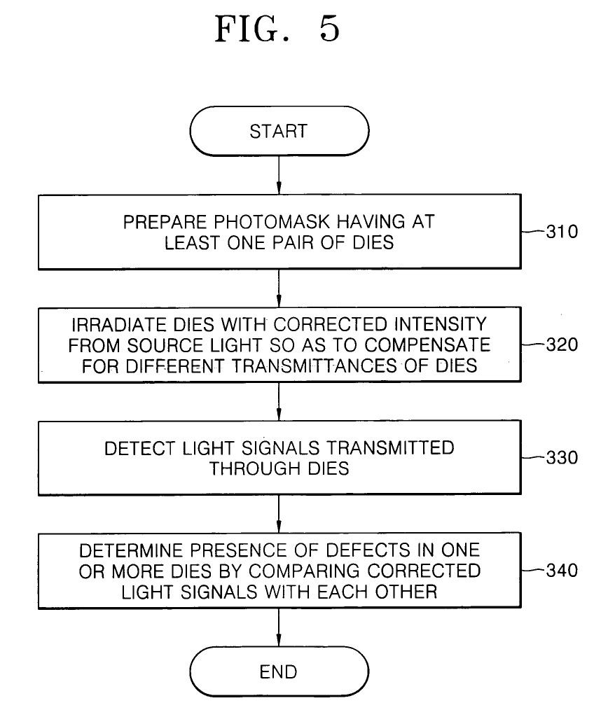

FIG. 5 is flow chart illustrating a method of inspecting defects in a photomask according to some embodiments of the present invention. The inspection method will be described with references to the above-described inspection method, and also to FIGS. 2 and 3.

First, a photomask 100 having at least one pair of dies 110 and 120 with different transmittances from each other is prepared in operation 310.

Next, the dies 110 and 120 are irradiated with the corrected intensity of light compensating for differences in transmittance between the dies in operation 320. For example, the corrected light intensities are obtained by normalizing the source light intensity with respect to the transmittances of each of the dies 110 and 120. The method of normalizing the source light is described above. For example, the corrected light intensities Iₒ₁ for the first die 110 and Iₒ₂ for the second die 120 can be obtained by dividing the source light intensity Iₒ by the transmittance of the first die α in the first transmittance correction map 115 and by the transmittance of the second die β in the second transmittance correction map 125, respectively.

Next, the light signals I₁ and I₂ respectively transmitted through dies 110 and 120 are detected in operation 330. If the dies 110 and 120 have no defect, the light signal intensities I₁ and I₂ are ideally the same as the source light intensity Iₒ because the light signal intensities I₁ and I₂ can be separately calculated by multiplying the corrected light intensities Iₒ₁ and Iₒ₂ by the transmittances α and β, respectively. However, as a result of using the transmittance correction maps 115 and 125, the light signal intensities I₁ and I₂ would actually not be insignificantly different from the source light intensity Iₒ due to the difference between the actual transmittances of the dies 110 and 120 from the calculated transmittances. However, when at least one of the dies 110 and 120 has one or more defects, the difference between the intensities I₁ and i₂ of the light signals becomes significant.

Next, the presence of at least one defect in the dies 110 and 120 is determined by comparing the intensities I₁ and I₂ of the light signals with each other in operation 340. The defect determination in the operation 340 is performed in the same manner as the defect determination in operation 240 described above. Therefore, according to some embodiments of the invention, defects on the photomask 100 can be detected by compensating for different transmittances of a transmittance corrected photomask 100, such as a customized photomask.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of inspecting defects in a photomask, the method comprising:
irradiating a photomask, which has at least one pair of dies having corresponding patterns with each other and different transmittances from each other;
detecting light signals transmitted through the one pair of dies;
correcting the light signals so as to compensate for the different transmittances of the one pair of dies; and
determining whether or not a defect is present in at least one of the one pair of dies by comparing the corrected light signals with each other.

2. The method of claim 1, wherein irradiating the light and detecting the light signals are sequentially performed for each of the one pair of dies.

3. The method of claim 1, wherein in correcting the light signals, the light signals transmitted through the one pair of dies are normalized with respect to the respective transmittances of the one pair of dies.

4. The method of claim 3, wherein the normalization is performed by dividing the light signals of the one pair of dies by the transmittances of the respective dies.

5. The method of claim 1, wherein in correcting the light signals, one of the light signals transmitted through the one pair of dies is multiplied by the respective transmittance ratios of the one pair of dies.

6. The method of claim 1, further comprising setting one of a pair of the dies as a reference die and setting the other of the pair of dies as an inspection die, wherein determining whether or not a defect is present comprises determining whether or not a defect is present in the inspection die by comparing the corrected light signals transmitted through the reference die with the corrected light signals transmitted through the inspection die.

7. The method of claim 1, wherein the transmittances of the one pair of dies are obtained using transmittance correction maps and the photomask is a customized photomask in which the transmittances of the one pair of dies are corrected using the respective transmittance correction maps.

8. The method of claim 1, further comprising defining each of the dies in the photomask as a plurality of pixel areas prior to irradiating the photomask, wherein the operations of irradiating, detecting the light signals, correcting the light signals, and determining the presence of the defects are performed separately for each of the pixels.

9. A method of inspecting defects in a photomask, the method comprising:
providing a photomask having at least one pair of dies having corresponding patterns with each other and different transmittances from each other;
irradiating the one pair of dies with light from a light source, wherein intensities of light signals are corrected so as to compensate for the different transmittances of the one pair of dies;
detecting light signals transmitted through the one pair of dies; and
determining whether or not a defect is present in at least one of the one pair of dies by comparing the intensities of the corrected light signals with each other.

10. The method of claim 9, wherein light from the light source is normalized with respect to the transmittances of the respective dies.

11. The method of claim 10, wherein in the normalization, light from the light source is divided by the transmittances of the respective dies.

12. The method of claim 9, further comprising setting one of a pair of dies as a reference die and setting the other as an inspection die, wherein determining whether or not a defect is present comprises determining whether or not a defect is present in the inspection die by comparing the light signals transmitted through the reference die with the light signals transmitted through the inspection die.

13. The method of claim 9, wherein the transmittances of the one pair of dies are obtained using transmittance correction maps and the photomask is a customized photomask in which the transmittances of each of the dies are corrected using the transmittance correction maps.

14. The method of claim 9, further comprising defining each of the dies as a plurality of pixel areas before irradiating the one pair of dies, wherein the operations of irradiating, detecting the light signals, and determining the presence of defects are performed separately for each of the pixels.

15. A method of inspecting defects in a photomask, the method comprising:
irradiating a photomask, which has at least one pair of dies having corresponding patterns with each other and transmittances corrected by corresponding transmittance maps;
detecting light signals transmitted through the one pair of dies;
normalizing the light signals using the transmittance correction maps of the one pair of dies; and
determining whether or not a defect is present in at least one of the one pair of dies by comparing the normalized light signals with each other.

16. The method of claim 15, wherein normalizing the light signals is performed by dividing light signals transmitted through the one pair of dies by the transmittances of the respective dies.

17. The method of claim 15, further comprising setting one of a pair of dies as a reference die and setting the other of the pair of dies as an inspection die, whether determining whether or not a defect is present comprises determining whether or not a defect is present in the inspection die by comparing the normalized light signals transmitted through the reference die with the normalized light signals transmitted through the inspection die.

18. The method of claim 15, further comprising defining each of the dies in the photomask a plurality of pixel areas before irradiating the photomask, wherein the operations of irradiating, detecting the light signals, and determining the presence of detects are performed separately for each of the pixels.
